(19) United States
(12) Patent Application Publication
(10) Pub. No.: US 2014/0362785 A1
(43) Pub. Date: Dec. 11, 2014

(54) Mapping Via Back To Back Ethernet Switches

(71) Applicant: Max4G, Inc., Eden Prairie, MN (US)

(72) Inventors: Vladimir Z. Kelman, Plymouth, MN (US); Anthony J. Klein, St. Paul, MN (US); Jeffrey T. Stern, Minnetonka, MN (US)

(21) Appl. No.: 14/296,584

(22) Filed: Jun. 5, 2014

Related U.S. Application Data
(60) Provisional application No. 61/831,569, filed on Jun. 5, 2013.

(51) Int. Cl. H04L 12/947; H04L 12/931; H04W 88/08

(52) U.S. Cl. CPC H04L 49/25; H04W 88/08; H04L 49/351
USPC 370/329

(57) ABSTRACT

A base station in a fixed wireless point to multi-point communication system includes a MAC processor and inner and outer Ethernet switches. The inner Ethernet switch communicates with the outer Ethernet switch on a plurality of ports, with packets to or from each connected remote station always traveling over a single inter-switch port pair dedicated to that remote station. Mapping the base station-remote links' downstream packets from the MAC processor is achieved with tags added in the inner Ethernet switch (downstream packets, based upon which inter-switch port pair carried the packet) and in the MAC processor (upstream packets).

### CROSS-REFERENCE TO RELATED APPLICATION(S)

The present application claims priority from Provisional Application No. 61/831,569, filed Jun. 5, 2013 and entitled “Wireless Point-to-Multi-Point Hub Remote Unit Mapping Using Back-to-Back Ethernet Switches”. The contents of U.S. provisional patent application Ser. No. 61/831,569 are hereby incorporated by reference in entirety.

### BACKGROUND OF THE INVENTION

The present invention relates to Point-to-Multipoint (“PtMP”) wireless communication systems having one or more base stations, each of which communicates (or is capable of communicating) with multiple remote units.

A PtMP system consists of a single base station unit and one or more remote units. The remote units communicate with the base station unit, and vice versa, but the remote units do not directly communicate with each other. In PtMP systems wherein the base station performs remote-to-remote forwarding, the system allows the remote units to communicate with each other through the base station unit. PtMP wireless systems are typically used for cellular backhaul, cellular access, campus network and other wireless communication applications.

The base station unit in PtMP systems typically includes a medium access control, or “MAC”, processor, such as defined in IEEE Std 802-2001 “Standard for Local and Metropolitan Area Networks: Overview and Architecture”, incorporated by reference. The MAC processor performs layer-2 processing of the data link layer for packetized communication with each of the remote units. Upstream from the MAC processor, the base station unit may include an Ethernet switch. The Ethernet switch commonly enables the base station unit, and the remote station units through the base station unit, to connect through a broadband Internet access pipeline (DSL modem, cable modem, or fiber Wide Area Network [WAN]) to the Internet or service provider. Both MAC processors and Ethernet switches are components that are well known and commercially available, at least in a “ready to be programmed/configured” state.

The base station unit maintains a base station-remote wireless link for each connected remote unit. A simple PtMP system that does not optimize for high data throughput might select a single modulation and coding scheme for all base station-remote links. The modulation and coding scheme is selected by determining what scheme would work over all links. This results in the following:
1. The throughput of all base station-remote links is reduced to the modulation and coding scheme that can be supported by the worst quality base station-remote link.
2. If all base station-remote links use the same modulation and coding scheme, then the base station doesn't have to perform any special processing of downstream packets, because every remote unit can decode all downstream packets.

However, this simple approach is not optimal. The individual base station-remote links of a deployed PtMP system are likely to be of differing quality and this quality may change over time. Modern PtMP systems are typically capable of using various modulations and coding techniques to adapt to the wireless link conditions, delivering the best data throughput possible. A PtMP system can provide much better results if the modulation and coding scheme of each base station-remote link is managed separately, selecting the highest modulation and coding scheme for individual links.

This approach of managing the modulation and coding scheme for each remote unit separately, though, creates a packet switching challenge in the base station. A downstream packet must be transmitted over the wireless link at the proper modulation and coding scheme in order for the destination remote unit to be able to receive the packet. Therefore, the base station unit must determine and the MAC processor must know for which remote unit that downstream packet is destined. The assumption is that the base station MAC processor has one or a limited number of Ethernet interfaces; therefore, the downstream packets received by the base station MAC processor, through any one Ethernet port, can be destined for any of more than one remote unit. Without any external pre-processing, the base station MAC processor must maintain a host forwarding table in order to map the Ethernet MAC address of a destination device to a base station-remote link.

The host forwarding table and mapping of remote Ethernet MAC addresses in the MAC processor can require a lot of memory, significant processing power and time to accomplish the mapping, primarily due to multiplicity of remote devices and dynamic nature of their attachment to the network. Better and less costly methods of allowing dynamic modulation and coding schemes for communication between a base station and all of its connect remote stations are needed.

### BRIEF SUMMARY OF THE INVENTION

The present invention provides a method and the embodiment of a fast and simple base station packet switching technique. The base station includes a MAC processor and inner and outer Ethernet switches. The inner Ethernet switch communicates with the MAC processor through a remote mapping tunnel which carries all the data packets for all the connected remote stations. The inner Ethernet switch communicates with the outer Ethernet switch on a plurality of ports, with packets to or from each connected remote station always traveling over a single inter-switch port pair dedicated to that remote station. Mapping the base station-remote links' downstream packets from the MAC processor is achieved with tags added to communications through the remote mapping tunnel, such tags in the downstream direction being added in the inner Ethernet switch based upon which inter-switch port pair carried the packet.

### BRIEF DESCRIPTION OF THE DRAWINGS

FIG. 1 is a schematic illustration of a single PtMP wireless system with a single base station unit connected to service provider network, with communication over wireless links to three remote units, each one of which providing connectivity to one or more serviced nodes, in accordance with one embodiment of the present invention.

FIG. 2 is a schematic illustration of major building block functional components of a base station unit, in accordance with one embodiment of the present invention.

While the above-identified drawing figures set forth a preferred embodiment, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

The present invention addresses the challenge of mapping downstream packets in the base station unit to destination remote units. The present invention proposes a solution for a PtMP wireless communication system base station unit to provide downstream packet mapping to base station-remote links using standard Ethernet switch hardware components (chips).

This disclosure uses the following terminology:

| Term/Acronym | Description |
|---|---|
| LAN | Local Area Network |
| 802.1Q tag | The 32-bit addition to Ethernet headers to provide virtual LAN |
| | (VLAN) assignment. |
| Coding | Technique used in the wireless physical layer to send |
| | redundant information in the data stream so that errors can be |
| | detected and possibly corrected. |
| Data-path | The Ethernet traffic of end-users (i.e. users of the system) |
| | travel through the PtMP data path. |
| Downstream | The data-path has an upstream and downstream direction for |
| | packets to and from end-users. The downstream direction is |
| | from the base station unit to a remote unit. |
| Upstream | The data-path has an upstream and downstream direction for |
| | packets to and from end-users. The upstream direction is from |
| | a remote unit to the hub (base station) unit. |
| External facing | Term used to describe the Ethernet switch ports that ‘face’ the |
| | external ‘world’ upstream of the base station. |
| Host forwarding table | A table maintained in an Ethernet switch that contains a |
| | mapping between host addresses and switch ports the packets |
| | are forwarded to. |
| Flooding | Packet flooding is a normal switch feature; when a switch is |
| | not aware of the destination port for a received packet (i.e. not |
| | in its host forwarding table), then the packet is duplicated by |
| | sending it out all active ports (other than the one it arrived |
| | through). This is opposed to the case where the switch has |
| | mapped a host (Ethernet address) to a port such that packets to |
| | that host are not duplicated but sent out the appropriate port. |
| PtMP | Point-to-Multi-Point |
| PtMP MAC | Point-to-Multi-Point MAC layer; this MAC layer provides |
| | access and forwarding services over the wireless media; the |
| | specifics of the PtMP MAC are not covered in detail in this |
| | document. |
| PtMP System | This document defines a PtMP system as a single base station |
| | unit with one or more wirelessly connected remote units. A |
| | PtMP system could have additional base station units each with |
| | one or more wirelessly connected remote units. |
| Base station | The device in a PtMP system that communicates with one or |
| | more remote units (i.e. many remotes communicate with a |
| | single base station unit). |
| Remote | The device in a PtMP system that communicates with one |
| | base station unit at a time (i.e. many remotes communicate |
| | with a single base station unit). |
| Base station-remote | The conceptual wireless radio transmission link between the |
| link | PtMP base station unit and a single remote unit; an operating |
| | base station unit has a base station-remote link to each remote |
| | with which it is currently communicating. |
| MAC | Medium Access Control |
| MAC processor | Term used to describe the processor or processors in the base |
| | station unit that operate the PtMP MAC and interface to the |
| | inner switch. This encompasses both MAC management and |
| | data-path operation. |
| Internal facing | Term used to describe the Ethernet switch ports that ‘face’ the |
| | MAC processor. |
| Inner switch | The Ethernet switch that connects to the MAC processor on |
| | one side and to the outer switch on the other (between the two). |
| Inter-switch ports | The set of switch ports connected between the inner and outer |
| | switches (in pairs). |
| Modulation | Technique used in the physical communication layer link to |
| | transmit a number of data bits over the wireless link; the |
| | selection of modulation that determines the number of bits |
| | being sent is dependent on the quality of the physical link. |
| Outer switch | The Ethernet switch that connects to the inner switch on one |
| | side and to the external ‘world’ (upstream from the base |
| | station) on the other. |
| PHY layer | In the case of this document the PHY layer refers to the |
| | physical layer of the wireless network stack. |
| Remote mapping tunnel | The tunnel between the back-to-back switches and the MAC |
| | processor where each packet is tagged with the ID of the |
| | associated remote unit. The tunnel uses one or more trunked |
| | ports. |

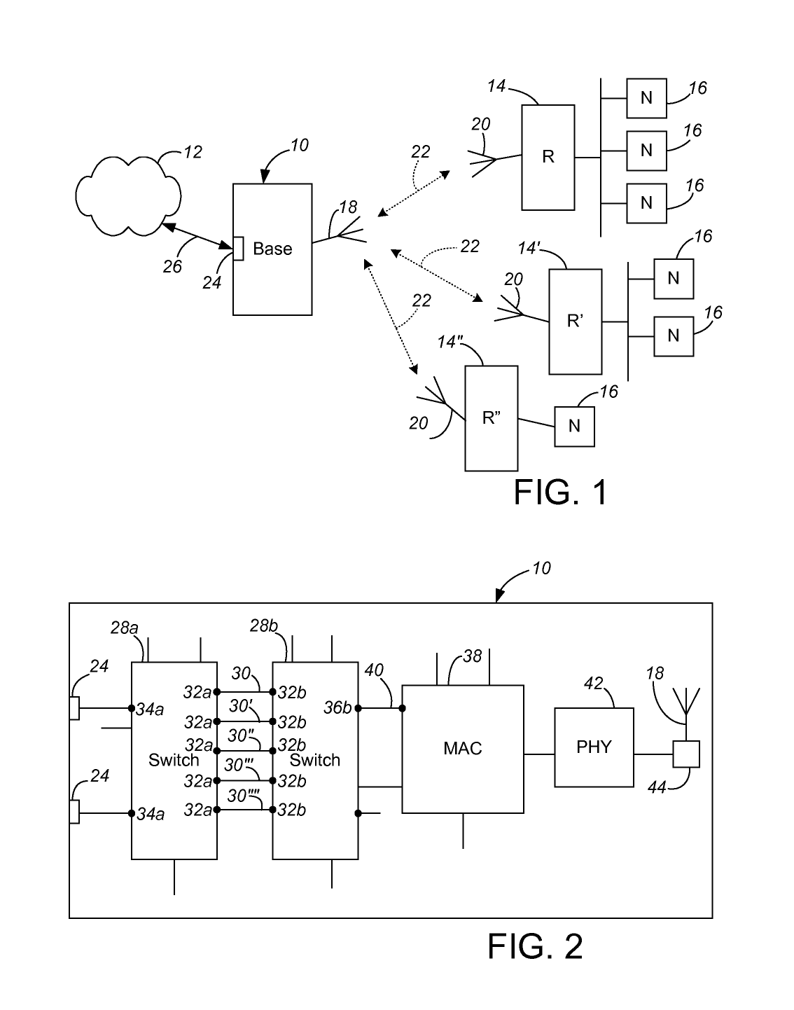

FIG. 1 illustrates a typical PtMP wireless system, where a base station unit 10, being connected to a service provider network 12, communicates with one or more remote units 14, 14′, 14″. Each one of the remote units 14, 14′, 14″ can be connected to one or more serviced nodes 16. The base station unit 10 includes an antenna 18, and each of the remote units 14 includes an antenna 20. The purpose of this illustrated system is to extend the service provider network 12 to the serviced nodes 16 over wireless airwaves 22. The wireless links 22 can be non-line-of-sight (NLoS) links traveling over street level distances (typically from 100 feet to several miles) such as in the sub-6 GHz range, for use in environments where fiber or microwave backhaul is neither practical nor feasible. In the preferred system, the modulation and coding scheme of each base station-remote link is managed separately, selecting the highest modulation and coding scheme for individual links. In the preferred system, each of the base station 10 and remote units 14, 14′, 14″ are fixed rather than mobile, meaning that during ordinary use each remains stationary rather than being handheld. The preferred system provides up to 900 Mbps of capacity with sub 1 ms latency.

On its upstream side, the base station unit 10 includes a connector 24 where the base station 10 communicates, in this case via a wired connection 26, with the service provider network 12. In the preferred embodiment, the connector 24 is an Ethernet connection such as through one or more RJ45 8 position 8 contact jacks. Other upstream connections could alternatively be used.

On its downstream side, the base station unit 10 maintains communication with each remote unit 14, 14′, 14″ and is responsible for switching the packets arriving at its upstream connector 24 from the service provider network 12 to the appropriate remote units 14, 14′, 14″ that are then delivered to service nodes 16, and vice versa.

The number of remote units 14 which can be handled by a single base station unit 10 is determined based upon the particular hardware components used in the base station unit 10, and the number of nodes 16 which can be handled by a single remote unit 14 is determined based upon the particular hardware components used in the remote unit 14. The present invention is primarily centered on the construction of the base station unit 10, and in the preferred embodiment the base station unit 10 can support up to five remote units 14 (only three shown). In any given geographic area, a large number of base station units 10 (only one shown) can operate over the same frequency band of wireless airwaves 22, or can operate over different frequency bands of wireless airwaves 22.

FIG. 2 illustrates the basic configuration of the major functional blocks of the base station 10 that provide the mapping solution according to present invention. The base station 10 includes two Ethernet switches connected together, designated as ‘outer switch’ 28a and ‘inner switch’ 28b. To provide a low cost solution, each of the Ethernet switches 28a, 28b are commercially available integrated circuit (chip) devices marketed as Ethernet switches. Each of the Ethernet switches 28a, 28b must have at least three ports for data flow, so that at least two ports (inter-switch port pairs) can be directly connected to each other in the back-to-back orientation. Preferably there are from three to fifteen inter-switch port pairs, with the most preferred embodiment including five inter-switch port pairs communication on connections 30, 30′, 30″, 30′″, 30″″. The inner switch 28b is required to support tagging, such as VLAN tagging (802.1Q and ad).

While the present invention could use any a wide variety of Ethernet switches, the preferred Ethernet switches 28a, 28b are from the LINK STREET line for SOHO and SMB markets from Marvell Technology Group Ltd. Of Santa Clara, Calif., such as two identical 88E6352 chips. Each Ethernet switch in the preferred embodiment is therefore a seven port switch, of which five ports 32a, 32b are directly connected 30, 30′, 30″, 30′″, 30″″ in the back-to-back switches as inter-switch port pairs. The preferred switch 28a, 28b is provided as a low cost 128-pin QFP (14×14 mm quad flat packaging), with five integrated triple-speed PHYs, BMII, RGMII and Serdes/SGMII interfaces, supporting the latest AVB (audio-video bridging) standards with 256 entry TCAM (ternary content addressable memory).

In the preferred embodiment, the outer switch 28a and the inner switch 28b are created from identical hardware components. In the preferred 88E6352 chips, each port uses eight of the 128 pins. For simplicity, each of the inter-switch port pairs 32a, 32b are directly wired 30, 30′, 30″, 30′″, 30″″, i.e., the 40 pins (pins not independently shown) representing five ports 32a on one 88E6352 chip 28a are directly wired to the same 40 pins (pins not independently shown) representing five ports 32b on the other 88E6352 chip 28b. As one alternative, the five communicating ports of the identical chips could be wired somewhat differently or with intervening components, so long as each port of the inter-switch port pairs effectively communicates with its corresponding port on the other Ethernet switch. As another alternative, different hardware components could be used for each of the Ethernet switches 28a, 28b provided both can communicate with each other as Ethernet switches using the same tagging system and across multiple inter-switch port pairs. As known with Ethernet switches, each Ethernet switch 28a, 28b has multiple other connections (only partially shown and unlabeled here) to power, control, program and perform other functions associated with each Ethernet switch 28a, 28b.

The outer switch 28a provides one or more ports 34a for service provider(s) network connections on the base station device 10, with the preferred embodiment providing two externally facing ports 34a. These ports 34a are typically directly connected to external connectors 24, but may also be connected to some other device (not shown) that is internal to the base station 10 and intermediate the externally facing port 34a and its connector 24 and wired connection 26 to the service provider network 12.

There is at least one port 36b for connection from the inner switch 28b which is connected downstream to a MAC processor 38; however, there could be more than one (i.e. as trunked ports) if more bandwidth is required. The connection between the port 36b and the MAC processor is referred to as the remote mapping tunnel 40. The remote mapping tunnel 40 could utilize more than one port 36b connecting between the inner switch 28b and the MAC processor 38 if the ports 36b are trunked, and the term “trunked connection” refers to one or more connections between the MAC processor 38 and the inner switch 28b which carry all the data packets for the remote units 14.

The present invention presents a method that moves the responsibility of mapping the base station-remote links' downstream packets from the MAC processor 38 to the back-to-back connected Ethernet switches 28a, 28b in the base station unit 10 through the use of outer tags applied to all packets being transmitted/processed between the MAC processor 38 and the inner switch 28b. The method of applying and using such outer tags will now be described.

A packet's outermost tag contains the ID of the remote unit 14, 14′, 14″ it is destined for or has been received from. In the downstream direction, the MAC processor 38 uses the ID from the tag to forward a packet across the proper base station-remote link 22.

The base station 10 assigns an ID to each remote unit 14, 14′, 14″ to which it is connected. The range of the ID is constrained by the valid VLAN ID values using 12 bits (from 1 to 4094). Each ID in the set of IDs in use at any one time must be unique within the base station unit 10 itself, but does not have to be unique across a deployment of multiple PtMP systems. If desired, it can be unique across a deployment if remote units 14 are allowed to detach from one base station unit 10 and reattach to a different base station unit (not shown). The ID should be assigned to a remote unit 14 upon network entry prior to forwarding any end-user packets.

The format of the tag used across the remote mapping tunnel 40, between the inner switch 28b and the MAC processor 38, is the standard format defined in IEEE 802.1Q. The table below shows the standard format:

16 bits

| 16 bits | 3 bits | 1 bit | 12 bits |
|---|---|---|---|
| TPID | Priority | Drop-Eligible Indicator | VLAN ID |

The tag's 12-bit VLAN (Virtual Local Area Network) ID field is set equal to the ID of the associated remote unit 14. The priority and drop-eligible indicator fields are not required to be used, however the priority field can be used to provide additional priority information to either the MAC processor 38 or to the egress port 36b on the inner switch 28b.

The tag protocol identifier field (TPID), which is the first 16 bits of the 32-bit tag, can be set to whatever value the inner switch 28b supports for service provider tagging. A typical value would be the standard provider bridging value from IEEE 802.1ad (0x88a8).

Packets to all remotes 14, 14′, 14″ that are forwarded through the remote mapping tunnel 40 contain this tag, following the source Ethernet MAC address, as a way to identify the associated remote unit 14, 14′, 14″. A packet may already have one or more service provider tags—the remote mapping tunnel tag is added as the outermost tag. The MAC processor 38 adds the tag to each upstream packet, before forwarding it to the inner switch 28b. The inner switch 28b adds the tag to each downstream packet, before forwarding it to the MAC processor 38.

The remote mapping tunnel tag is only used to communicate the remote unit ID with which the packet is associated. The inner switch 28b strips the tag before forwarding the packet to the outer switch 28a. The MAC processor 38 strips the tag before forwarding the packet over the air 22.

In some cases, a service provider may already have double-tagged frames. In such cases, the present invention is predicated on the fact that the inner switch 28b is capable of adding or removing a third tag. Accordingly, the inner switch 28b may need to support triple VLAN (802.1Q and ad) tagging if the PtMP system is required to bridge Q-in-Q (double tagged) packets.

In the downstream direction, the inner switch 28b receives a packet on an external facing port 32b destined for one particular remote unit. So, in this example, connection 30 only carries packets to or from remote unit 14, connection 30′ only carries packets to or from remote unit 14′, connection 30″ only carries packets to or from remote unit 14″, etc. The packet is assigned a VLAN ID that matches the remote unit ID assigned by the MAC processor 38. The remote mapping tag is added to the packet before it is sent over the remote mapping tunnel 40 to the MAC processor 38. When the MAC processor 38 receives the packet, it determines the remote unit destination by extracting the remote unit ID from the remote mapping tag and then strips the tag before forwarding the packet to the physical layer 42 for transmission via radio 44.

In the upstream direction, the inner switch 28b receives a packet over the remote mapping tunnel 40. The remote mapping tag contains the ID of the remote unit 14, which is used by the inner switch 28b as a VLAN ID. The packet is assigned to that VLAN. Each upstream facing port 32b of the inner switch 28b forwards traffic for a single remote unit 14 and is a member of a single VLAN that matches its remote ID. An upstream packet is forwarded based on its assigned VLAN ID, therefore, to the single proper upstream facing port 32b of the inner switch 28b.

The internal facing port(s) 36b of the inner switch 28b on one end of the remote mapping tunnel 40 are preferably configured as follows:
On ingress, these ports 36b assign the received packet to the VLAN taken from the outer tag's VID field.
On ingress, the remote mapping tag should be removed (or it can be removed on egress through ports 32b).
On egress, these ports 36b add an outer tag. The VLAN ID of the outer tag is set to the assigned ID of the remote unit 14.
These ports 36b must be configured as service provider ports, such that an additional tag will be added to already tagged packets.
Each remote unit 14 is assigned an ID, which is used as a VLAN ID. Therefore, these ports 36b must be members of the set of VLANs that includes all remote unit IDs.

The external (upstream) facing ports 32b on the inner switch 28b should be disabled prior to being configured. Upon base station unit 10 startup, none of these ports 32b should be enabled (or they should be disabled before normal operation and be required to be explicitly enabled).

Each port 32b of the inner switch 28b forwards packets for a single remote unit 14. So, in this example, connection 30 only carries packets to or from remote unit 14, connection 30′ only carries packets to or from remote unit 14′, connection 30″ only carries packets to or from remote unit 14″, etc. In other words, each remote unit 14 has its own dedicated external facing port 32b on the inner switch 28b and only its traffic passes through that port 32b. Each external facing port 32b of the inner switch 28b is preferably configured as follows:
No forwarding is allowed to other external facing ports 32b (only to one or more internal facing ports 36b). Forwarding to other external facing ports 32b would be operationally destructive because it would create loops between the inner and outer switches 28a, 28b. Forwarding between the external facing ports 32b is not meaningful within this architectural definition. The inner switch 28b is used primarily to exchange the remote unit ID of a packet with the MAC processor 38.
The default VLAN ID (or PVID (port default VLAN ID)) of each port 32b must match the ID of the remote 14, 14′, 14″ with which the port 32b is associated.
The port 32b must change its policy to assign the PVID as the VLAN ID for received packets (from the outer switch 28a). These switch ports 32b cannot assign the VLAN ID from a tag within the received packet.
The port 32b must be assigned as a member of the VLAN that coincides with the remote unit's ID for which this port 32b forwards packets.
If the internal facing ports 36b do not strip the remote mapping tag, then on egress, the port 32b must remove that tag.

The outer switch 28a is configured so that each one of the remote units' packets are accessible through one of the internal facing ports 32a. In the upstream direction, a packet is received through one of outer switch's 28a internal facing ports. The packet is forwarded to any of the other ports 32a, 34a, based on the internal host forwarding table of the outer switch 28a. If the destination host is unknown to the switch 28a, the packet is flooded to all other ports 32a, 34a in the switch 28a, including the other internal facing ports 32a to the other remote units 14. The transmission of multiple copies of ‘flooded’ packets to remote units 14 can be reduced to a single copy of the packet as explained in the following discussion of the downstream broadcast channel.

In the downstream direction, a packet enters through one of the external facing ports 34a of the outer switch 28a. The packet is forwarded to the proper internal facing port 32a, based on the internal host forwarding table of the outer switch 28a. As in the upstream case, a packet is flooded to all internal facing ports 32a if the destination host isn't found in the host forwarding table. There are no special configuration rules for ports 32a 34a on the outer switch 28a.

Thus, in the outer switch's port-to-port connection mappings to the inner switch 28b, packets to/from any single remote unit 14 always pass through a correspondingly assigned single inter-switch port pair. The inner switch 28b is configured with the appropriate VLAN IDs and the port to port mapping configuration as described above.

When a remote unit 14 accomplishes network entry, the MAC processor 38:
Assigns a unique ID to the remote unit 14 (unique within the base station 10) or uses a pre-assigned ID.
Selects an unused external facing port 32b in the inner switch 28b, or uses a pre-assigned port 32b.
Configures the selected port 32b of the inner switch 28b, which includes assigning the port VLAN ID equal to the remote unit's ID. In some implementations, it may be possible to configure the port 32b once and then never need to again.

The broadcast packets are replicated for each remote unit 14, 14′, 14″ on the downstream. For example, a downstream broadcast packet enters the outer switch 28a through an external facing port 34a. The packet is then forwarded to each internal facing port 32a that has an active remote unit 14 associated with it, in this example over connections 30, 30′ and 30″. The inner switch 28b receives up to n copies (in the preferred embodiment up to five copies) of the frame and assigns them to the VLAN of each active remote unit 14. The copies of the packet are then forwarded through the remote mapping tunnel 40 to the MAC processor 203, where all the copies are sent over the air.

On the upstream, the broadcast packets are received by the outer switch 28a through an internal facing port 32a. The outer switch 28a forwards the broadcast packets to all its external facing ports 34a and back to the inner switch 28b through all internal facing ports 32a, except the port that the packet was received through. Similar to broadcast packet handling, packet flooding produces multiple copies of a packet sent over the air 22 to each of the remote units 14.

The present invention can be applicable to the following two detachment/attachment cases:

1. Static case: remote units 14 are assigned to one and only one base station 10.

2. Dynamic case: remote units 14 can negotiate with available base station units 10 to connect to the network.

In addition to the presented static case discussion, the present invention is also applicable to the dynamic case. The important difference is that in a dynamic case, a remote unit 14 can detach and reattach to a different base station 10 in the network. If a remote unit 14 does this and has at least one end-node 16 downstream of it, the host forwarding table in the outer switch 28a may have incorrect ‘locations’ of the downstream end-user nodes 16 associated with the reattached remote unit 14. Even without any changes, this situation is temporary and is resolved when the outer switch's 28a host forwarding table entries time out for the downstream end-hosts 16 that ‘moved’ within the network. A typical timeout is 5 minutes. Upon switching its connection with the base station 10; however, it is best for the moving remote unit 14 to send an upstream gratuitous unicast address resolution protocol (ARP) standard packet for each attached node 16, in order to update the switched network, including the host forwarding table in the outer switch 28a.

The mapping described herein occurs entirely in the base station unit 10. Remote units 14 do not require the additional Ethernet switch hardware. Through this structure and method, the host forwarding table and mapping of remote Ethernet MAC addresses in the MAC processor is avoided.

Although the present invention has been described with reference to preferred embodiments, workers skilled in the art will recognize that changes may be made in form and detail without departing from the spirit and scope of the invention.

What is claimed is:

1. A base station for use in a point-to-multi-point communication with a plurality of remote stations, comprising:
a MAC processor connected to a communication physical layer for transmitting and receiving communications from each of the remote stations over links;
an inner Ethernet switch communicating with the MAC processor through a trunk connection which carries all the data packets to and from all the connected remote stations, the inner Ethernet switch having a plurality of Ethernet ports; and
an outer Ethernet switch having a plurality of Ethernet ports, with each of the plurality of Ethernet ports of the outer Ethernet switch having a dedicated connection to a single Ethernet port on the inner Ethernet switch to thereby define Ethernet port sets, the data packets to and from any one connected remote station being transmitted through a single Ethernet port set which has been assigned to that remote station, the outer Ethernet switch having one or more additional ports for external network connections on the base station device;
wherein mapping the base station-remote links' packets is achieved with tags added to data packets based upon the Ethernet port set being used between the inner and outer Ethernet switches.

2. The base station of claim 1, wherein a modulation and coding scheme of each base station-remote link is managed separately.

3. The base station of claim 1, wherein the inner Ethernet switch adds tags to downstream directed data packets based upon the Ethernet port of the Ethernet port set on which the downstream directed data packet was received, such that downstream directed data packets are tagged when communicated on the trunk connection.

4. The base station of claim 3, wherein the MAC processor strips the tags added by the inner Ethernet switch from the downstream directed data packets prior to providing the downstream directed data packets to the communication physical layer for transmission.

5. The base station of claim 1, wherein the MAC processor adds tags to upstream directed data packets based upon the connected remote station from which the upstream directed data packet was received, such that upstream directed data packets are tagged when communicated on the trunk connection.

6. The base station of claim 5, wherein the inner Ethernet switch strips the tags added by the MAC processor from the upstream directed data packets prior to providing the upstream directed data packets to the assigned Ethernet port set.

7. The base station of claim 6, wherein the inner Ethernet switch adds tags to downstream directed data packets based upon the Ethernet port of the Ethernet port set on which the downstream directed data packet was received, such that both upstream directed data packets and downstream directed data packets are tagged when communicated on the trunk connection.

8. The base station of claim 7, wherein the MAC processor strips the tags added by the inner Ethernet switch from the downstream directed data packets prior to providing the downstream directed data packets to the communication physical layer for transmission to the remote stations.

9. The base station of claim 1, wherein the base station can communicate with at least three remote stations,
wherein the inner Ethernet switch has a first Ethernet port connected to a first Ethernet port of the outer Ethernet switch to define a first Ethernet port set which carries data packets to and from only a first remote station;
wherein the inner Ethernet switch has a second Ethernet port connected to a second Ethernet port of the outer Ethernet switch to define a second Ethernet port set which carries data packets to and from only a second remote station;
wherein the inner Ethernet switch has a third Ethernet port connected to a third Ethernet port of the outer Ethernet switch to define a third Ethernet port set which carries data packets to and from only a third remote station.

10. The base station of claim 9, wherein the base station can communicate with five remote stations,
wherein the inner Ethernet switch has a fourth Ethernet port connected to a fourth Ethernet port of the outer Ethernet switch to define a fourth Ethernet port set which carries data packets to and from only a fourth remote station;
wherein the inner Ethernet switch has a fifth Ethernet port connected to a fifth Ethernet port of the outer Ethernet switch to define a fifth Ethernet port set which carries data packets to and from only a fifth remote station.

11. The base station of claim 1, wherein the connections between Ethernet port sets on the inner and outer Ethernet switches are direct connections without any intervening electrical components.

12. The base station of claim 1, wherein the added tags are outermost tags in a standard format defined in IEEE 802.1Q.

13. The base station of claim 1, wherein the links are wireless links, and both the base station and the remote stations are fixed rather than mobile.

14. A method of handling data packets in a base station for use in a point-to-multi-point communication with a plurality of remote stations, comprising:
transmitting and receiving communications from each of the remote stations over links with a MAC processor via a communication physical layer;
carrying all the data packets to and from all the connected remote stations through a trunk connection between the MAC processor and an inner Ethernet switch, the inner Ethernet switch having a plurality of Ethernet ports;
transmitting the data packets through an outer Ethernet switch having a plurality of Ethernet ports, with each of the plurality of Ethernet ports of the outer Ethernet switch having a dedicated connection to a single Ethernet port on the inner Ethernet switch to thereby define Ethernet port sets, data packets to and from any one connected remote station being transmitted through a single Ethernet port set which has been assigned to that remote station, the outer Ethernet switch having one or more additional ports for external network connections on the base station device; and
mapping the base station-remote links' packets by adding tags to data packets corresponding to the Ethernet port set being used between the inner and outer Ethernet switches.

15. The method of claim 14, further comprising:
assigning an ID to each connected remote unit;
configuring the inner Ethernet switch to use each ID as a VLAN ID, with different Ethernet ports of the inner Ethernet switch assigned to different VLAN IDs; and
upon ingress of an upstream directed data packet, assigning the packet to the VLAN ID taken from the tag and transmitting the packet on the Ethernet port assigned to that VLAN ID.

16. The method of claim 15, further comprising:
in the inner Ethernet switch, stripping the tag from the upstream directed data packet prior to transmitting the packet on the Ethernet port assigned to that VLAN ID.

17. The method of claim 14, further comprising:
configuring a port on the inner Ethernet switch which provides the trunk connection with the MAC processor as a service provider port.

18. The method of claim 14, further comprising:
assigning an ID to each connected remote unit;
configuring the inner Ethernet switch to use each ID as a VLAN ID, with different Ethernet ports of the inner Ethernet switch assigned to different VLAN IDs; and
upon egress of a downstream directed data packet, tagging the packet with a tag associated with the VLAN ID of the from Ethernet port which received the packet, providing the packet to the MAC processor with the tag.

19. The method of claim 14, further comprising:
in the MAC processor, stripping the tag from the downstream directed data packet prior to providing the packet to the communication physical layer for wireless transmission to the remote station.

20. A wireless point-to-multi-point communication system, comprising:
a plurality of remote stations;
a base station transmitting and receiving communications from each of the remote stations over wireless links, the base station comprising:
a MAC processor connected to a communication physical layer for transmission and reception;
an inner Ethernet switch communicating with the MAC processor through a trunk connection which carries all the data packets to and from all the connected remote stations, the inner Ethernet switch having a plurality of Ethernet ports; and
an outer Ethernet switch having a plurality of Ethernet ports, with each of the plurality of Ethernet ports of the outer Ethernet switch having a dedicated connection to a single Ethernet port on the inner Ethernet switch to thereby define Ethernet port sets, the data packets to and from any one of the remote stations being transmitted through a single Ethernet port set which has been assigned to that remote station, the outer Ethernet switch having one or more additional ports for external network connections on the base station device;
wherein mapping the base station-remote links' packets is achieved with tags added to data packets based upon the Ethernet port set being used between the inner and outer Ethernet switches.
